(19) United States
(12) Patent Application Publication
(10) Pub. No.: US 2004/0254839 A1
(43) Pub. Date: Dec. 16, 2004

(54) Sales supporting method, program, and recording medium

(75) Inventor: Yugo Nishimura, Yokohama (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/890,257

(22) Filed: Jul. 14, 2004

Related U.S. Application Data
(63) Continuation of application No. PCT/JP02/03116, filed on Mar. 28, 2002.

(51) Int. Cl. G06F 17/60

(52) U.S. Cl. 705/14

(57) ABSTRACT

A method for supporting sales of a commodity to a customer is disclosed. The method includes the steps of a) computing a first discount value for a deficient (out of stock) commodity desired by the customer, by referring to arrival information of the deficient commodity; b) storing desired commodity information that is stored in correspondence with the obtained first discount value, the commodity information including details of the deficient commodity, and customer identification information including identification information of the customer; and c) discounting the price of the desired deficient commodity in accordance with the obtained first discount value, in a case where the customer purchases the desired deficient commodity.

### BACKGROUND OF THE INVENTION

1. Field of the Invention

The present invention generally relates to a sales supporting method for supporting sales, for example, by discounting a prescribed commodity purchased as an alternative for a commodity that is out of stock. Further, the present invention relates to a program for enabling a computer to execute the procedures of the sales supporting method, and a recording medium containing the program.

2. Description of the Related Art

Conventionally, in a case where there are too many leftover commodities, it is possible that the period for selling the leftover commodities may expire or that out of date commodities may not be purchased, thereby causing a store selling the commodities to suffer sales losses. Accordingly, the store orders commodities and adjusts its stock of commodities so that leftover commodities can be as few as possible.

Nevertheless, since the store aims to adjust its stock without having too many leftover commodities, there may be a case where a commodity desired by a customer is out of stock, that is, sold out.

Furthermore, there may be a case where the commodity desired by the customer may not be sold at the store in the first place. In such a case where the store lacks the commodity, the customer may go to another store for purchasing the commodity. Accordingly, the store with such lack of commodities eventually will lose its customers. This results in loss of opportunities to sell the commodities and to the reduction of profit.

In a case where there is such lack of commodities, it is possible for the customer to order the commodity and wait for the next arrival of the commodity. However, for the customer, if there is no benefit in waiting for the arrival of the commodity, the customer may lose has/her desire to purchase the commodity at the store.

### SUMMARY OF THE INVENTION

It is a general object of the present invention to provide a sales supporting method, a program, and a recording medium that substantially obviate one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a sales supporting method and a program particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides a method for supporting sales of a commodity to a customer, the method comprising the steps of: a) computing a first discount value for a deficient commodity desired by the customer, by referring to arrival information of the deficient commodity; b) storing desired commodity information that is stored in correspondence with the obtained first discount value, the commodity information including details of the deficient commodity, and customer identification information including identification information of the customer; and c) discounting the price of the desired deficient commodity in accordance with the obtained first discount value, in a case where the customer purchases the desired deficient commodity.

According to an embodiment of the present invention, the sales supporting method may further include a step of: d) storing alternative information including information of an alternative commodity that is alternatively purchasable for the desired deficient commodity, and a second discount value corresponding to the alternative commodity.

According to an embodiment of the present invention, the sales supporting method may further include a step of: e) discounting the price of the alternative commodity in accordance with the second discount value, in a case where the customer purchases the alternative commodity.

According to an embodiment of the present invention, the sales supporting method may further include a step of: f) outputting a receipt indicative of discount results for at least one of the discounted price according to the first discount value and the discounted price according to the second discount value.

According to an embodiment of the present invention, the sales supporting method may further include a step of: g) storing purchase information including at least one of the discounted price according to the first discount value and the discounted price according to the second discount value.

According to an embodiment of the present invention, the sales supporting method may further include a step of: h) deleting the desired deficient commodity information and the alternative commodity information corresponding to the discounted desired commodity.

According to an embodiment of the present invention, the sales supporting method may further include a step of: i) displaying the desired commodity information and the purchase information.

Furthermore, the present invention provides a program for enabling a computer to execute a sales supporting method, the program comprising the functions of: a) computing a first discount value for a deficient commodity desired by the customer, by referring to arrival information of the deficient commodity; b) storing desired commodity information that is stored in correspondence with the obtained first discount value, the commodity information including details of the deficient commodity, and customer identification information including identification information of the customer; and c) discounting the price of the desired deficient commodity in accordance with the obtained first discount value, in a case where the customer purchases the desired deficient commodity.

Furthermore, the present invention provides a recording medium stored with a program for enabling a computer to execute a sales supporting method, the recording medium including a program according to an embodiment of the present invention.

Other objects and further features of the present invention will be apparent from the following detailed description when read in conjunction with the accompanying drawings.

### BRIEF DESCRIPTION OF THE DRAWINGS

FIG. 1 is a schematic diagram showing an exemplary configuration of a sales supporting method according to an embodiment of the present invention;

FIG. 2 is a flowchart showing procedures of the sales supporting method according to an embodiment of the present invention;

FIG. 3 is another flowchart showing procedures of the sales supporting method according to an embodiment of the present invention;

FIG. 4 is further another flowchart showing procedures of the sales supporting method according to an embodiment of the present invention;

FIG. 5 is a schematic diagram showing a table stored in a reservation information DB according to an embodiment of the present invention;

FIG. 6 is a schematic diagram showing a table stored in an alternative information DB;

FIG. 7 is a schematic diagram showing a table stored in a deficient information DB;

FIG. 8 is a schematic diagram showing a table stored in an arrival information DB;

FIG. 9 is a schematic diagram showing a table stored in sales information DB;

FIG. 10 is a diagram showing an example of a display for explaining a sales supporting method according to an embodiment of the present invention;

FIG. 11A is a schematic diagram showing a receipt output by a sales supporting method according to an embodiment of the present invention; and

FIG. 11B is a schematic diagram showing a receipt output by a sales supporting method according to an embodiment of the present invention.

### DESCRIPTION OF THE PREFERRED EMBODIMENTS

In the following, embodiments of the present invention are described with reference to the accompanying drawings.

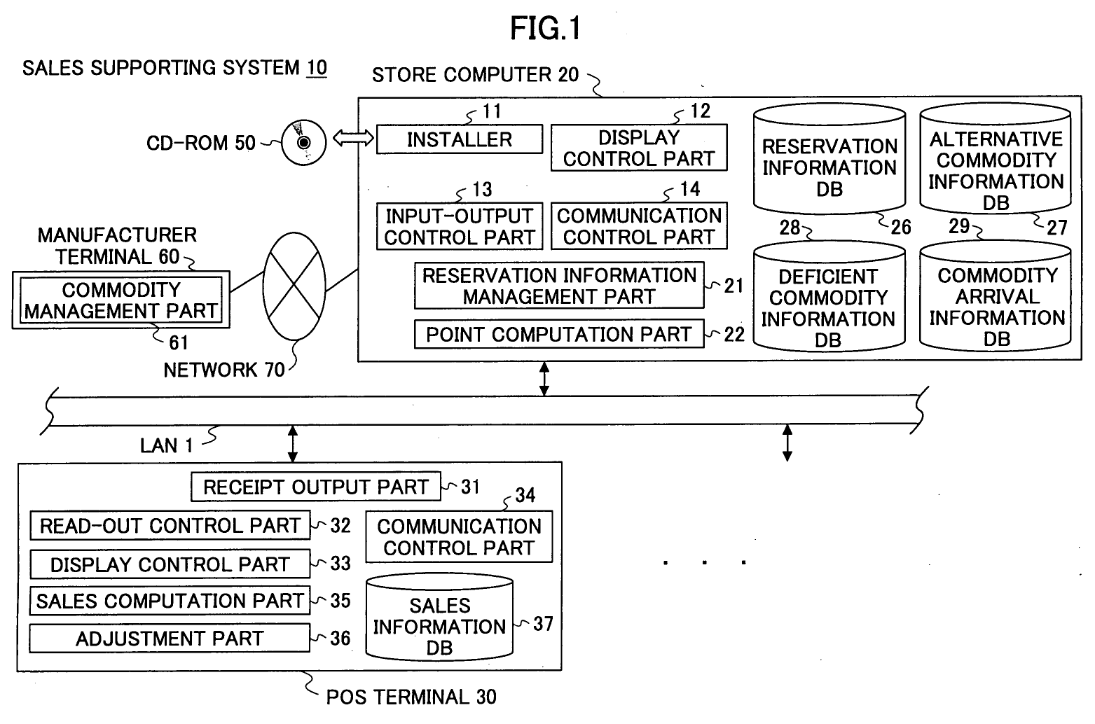

FIG. 1 is a schematic diagram showing an exemplary configuration of a system of the sales supporting method according to an embodiment of the present invention. In FIG. 1, a sales supporting system 10 of the sales supporting method is a system including a store computer 20 provided to a store, a plurality of POS (Point Of Sale) terminals 30, and a manufacturer terminal 60 established on the side of the manufacturer.

In FIG. 1, the store computer 20 is a server computer having each of its components controlled by a CPU (Central Processing Unit). The CPU executes the procedures of the sales supporting method according to a program stored in a memory unit. The store computer 20 is connected to the POS terminals 30 via a LAN (Local Area Network). The store computer 20 is connected to the manufacturer terminal 60 via a network 70.

The store computer 20 mainly includes, for example, an installer 11 for installing a program for executing sales supporting procedures, a display control part 12 for controlling the display of data, an input-output control part 13 for controlling input and output of data, a communication control part 14 for controlling data communications, a reservation information management part 21 for executing various procedures such as registration, deletion of reservation information based on information such as information from the POS terminals 30, a point computation part 22 for computing discount points based on the arrival date of the commodity desired by the customer, a reservation information DB (database) 26 for storing reservation information, an alternative commodity information DB (database) 27 for storing alternative commodity information in correspondence with deficient commodity information, a deficient commodity information DB (database) 28 for storing the deficient commodity information, and a commodity arrival information DB (database) 29 for storing the expected date of arrival of each commodity and actual date of the arrival.

The display control part 12, including a display unit such as a display, controls (processes) display data and displays the data on the display unit. The input-output control part 13 controls an input unit (e.g., mouse, keyboard) and an output unit (e.g., printer) for controlling input and output of data. The communication control part 14 is a process part for controlling data communications via the network 70 and the LAN 1, and includes a communication unit for connecting to the network 70 and the LAN 1. The installer 11 reads out a program for executing the sales supporting method according to an embodiment of the present invention from a CD-ROM 50, and installs the read out in a secondary storage apparatus or the like. When a process for executing the sales supporting method is activated, the CPU begins the process in accordance with the program installed in the secondary storage apparatus. It is to be noted that the medium for storing the program is not limited to the CD-ROM 50. Other computer readable media may be alternatively employed.

The reservation information management part 21 of the store computer 20 serves to register and/or delete reservation information (e.g., customer codes, reservation commodity codes, reservation dates obtained from the POS terminals 30, and commodity arrival dates stored in the commodity arrival information DB) in and/or from the reservation information DB 26. The point computation part 22 computes discount points based on the arrival date of a commodity, and stores the discount points in the reservation information DB 26.

The reservation information management part 21 stores commodity arrival dates obtained from the manufacturer terminal 60 in the commodity arrival information DB 29. Further, the reservation information management part 21, in response to a request from the POS terminal 30, transmits to the POS terminal 30 information including, for example, reservation information stored in the reservation information DB 26 and/or alternative commodity information stored beforehand in the alternative commodity information DB 27.

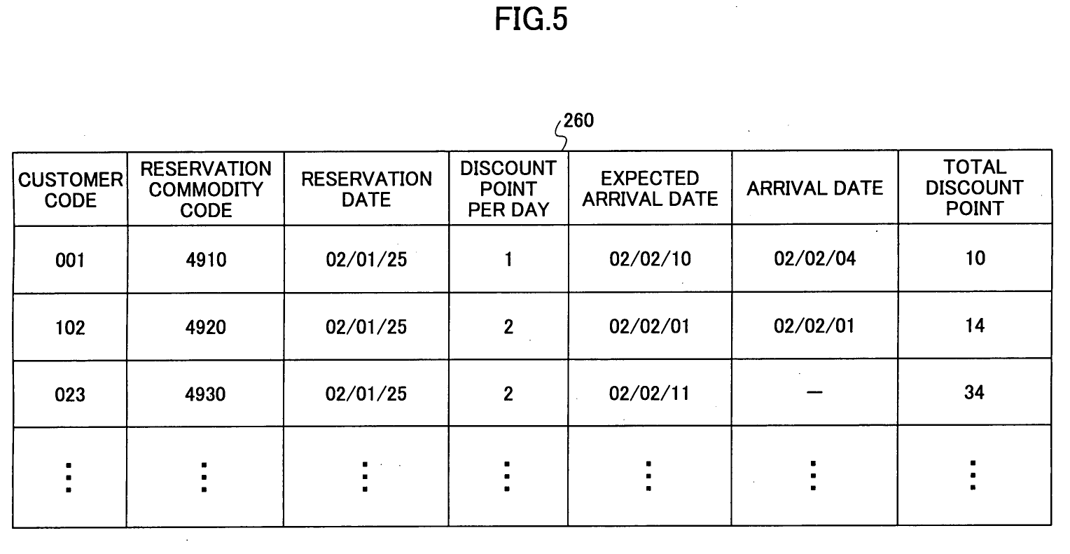

FIG. 5 shows a table 260 stored in the reservation information DB 26. In FIG. 5, the table 260 includes, for example, customer codes, reservation commodity codes, reservation dates transmitted from the POS terminals 30, discount points per day, expected arrival date of the reserved commodity, commodity arrival date, and the total discount points. More specifically, for example, in the first row in the table 260, the customer code is “001”, the reservation commodity code is “4910”, the reservation date is “Jan. 25, 2002”, the discount points per day is “1 (point)”, the expected arrival date is “Feb. 10, 2002”, the arrival date is “Feb. 4, 2002”, and the total discount points is “10 (points)”.

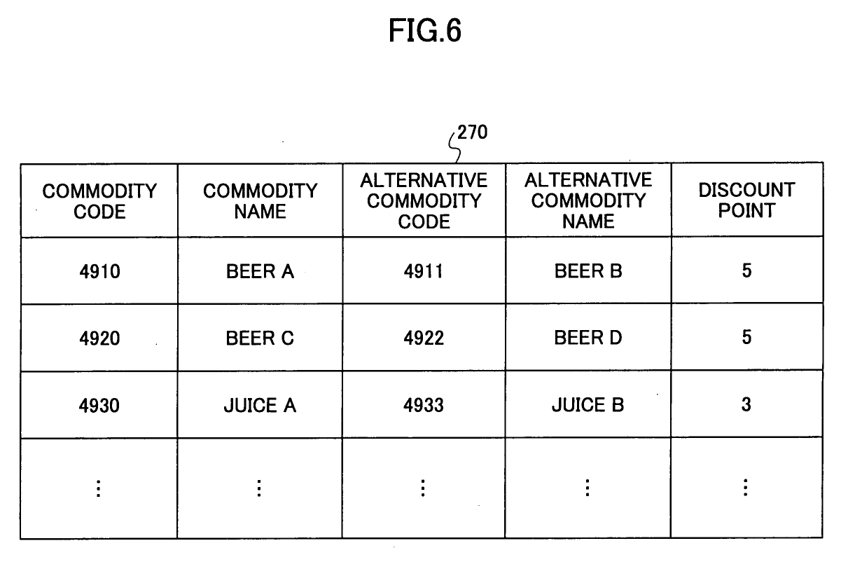

FIG. 6 shows a table 270 stored in the alternative commodity information DB 27. In FIG. 6, the table 270 includes, for example, commodity codes, commodity names corresponding to the commodity codes, alternative commodity codes, alternative commodity names corresponding to the alternative commodity codes, and the discount points when purchasing the alternative commodity. More specifically, for example, in the first row in the table 270, the commodity code is “4910”, the commodity name is “canned beer A”, the alternative commodity code is “4911”, the alternative commodity name is “canned beer B”, and the discount points is “5 (points)”.

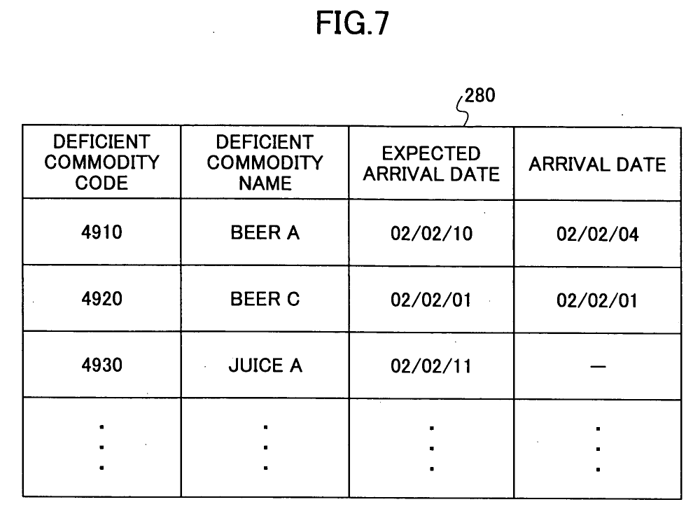

FIG. 7 shows a table 280 stored in the deficient commodity information DB 28. In FIG. 7, the table 280 includes, for example, deficient commodity codes, deficient commodity names corresponding to the deficient commodity codes, the expected arrival dates of the deficient commodity, and the arrival dates transmitted from the manufacturer terminal 60. More specifically, for example, in the first row in the table 280, the deficient commodity code is “4910”, the deficient commodity name is “canned beer A”, the expected arrival date is “Feb. 10, 2002”, and the arrival date is “Feb. 4, 2002”.

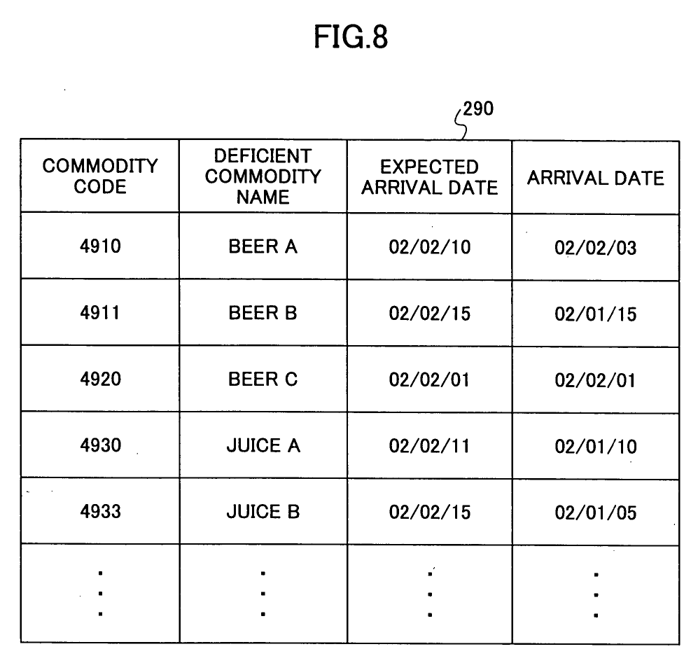

FIG. 8 shows a table 290 stored in the commodity arrival information DB 29. In FIG. 8, the table 290 includes, for example, commodity codes of the commodities sold in the store, commodity names, expected arrival dates of commodities, and arrival dates. More specifically, for example, in the first row in the table 290, the commodity code is “4910”, the commodity name is “canned beer A”, the expected arrival date is “Feb. 10, 2002”, and the arrival date is “Feb. 3, 2002”.

The POS terminal 30 mainly includes, for example, a receipt output part 31 for outputting a receipt during the purchase of a commodity, a read-out control part 32 for controlling data read out from a bar code reader or the like, a display control part 33 for controlling display of data, a communication control part 34 for controlling communication of data, a sales computation part 35 for computing the sales of the commodities, an adjustment part 36 for adjusting, for example, the total of sales based on the sales results of the commodities, and a sales information DB 37 for storing sales results. Since the display control part 33 and the communication control part 34 of the POS terminal 30 provide functions similar to those of the display control part 12 and the communication control part 14 of the store computer 20, description of the display control part 33 and the communication control part 34 is omitted.

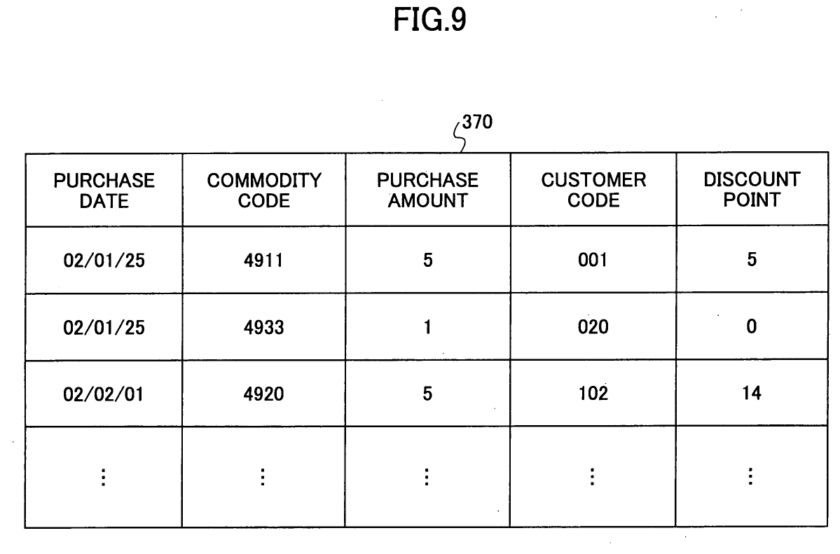

FIG. 9 shows a table 370 stored in the sales information DB 37. In FIG. 9, the table 370 includes, for example, purchase dates (representing when the commodity was purchased by the customer), commodity codes (representing the code of the purchased commodity), purchase amount (representing the amount of the purchased commodity), customer codes (representing the code of the customer purchasing the commodity), and discount points (representing the points discounted during the purchase of an alternative commodity or during a next purchase). More specifically, for example, in the first row in the table 370, the purchase date is “Jan. 25, 2002”, the commodity code is “4911”, the purchase amount is “5”, the customer code is “001”, and the discount points is “5”.

The manufacturer terminal 60 includes, for example, a commodity management part 61 which provides information (e.g. arrival date of a commodity) to the store computer 20 in response to a request from the store computer 20. It is to be noted that description of parts included in the manufacturer terminal 60 which provide the functions similar to the display control part 12, the input-output control part 13, the communication control part 14 of the store computer 20 are omitted.

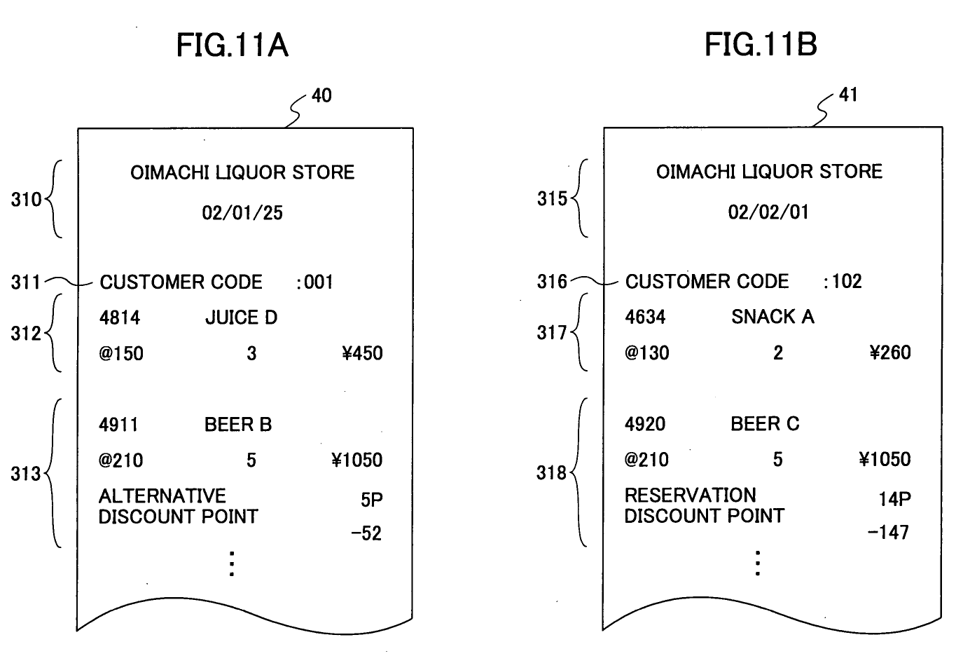

The POS terminal 30 with use of a bar code reader or the like reads out customer codes from a card with magnetic tape or with bar codes that have the customer codes registered therein. The read-out control part 32 controls the read out data. Likewise, the POS terminal 30 with use of the bar code reader or the like reads out commodity codes from a bar code attached to a commodity purchased by a customer or from a commodity tag, for example, for identifying a deficient commodity. According to the read-out customer codes and commodity codes, the sales computation part 35 and the adjustment part 36 compute the sales based on reservation information and/or alternative information from the store computer 20. The sales results are stores as sales information in the sales information DB 37. The sales results are displayed by a display unit (not shown) of the POS terminal 30. After the information for all of the purchased commodities is read out, the receipt output part 31 outputs a receipt of the sales results of the commodities. The receipt of the sales results is described below in further detail with reference to FIGS. 11A and 11B.

Next, the procedure of a sales supporting method according to an embodiment of the present invention is described.

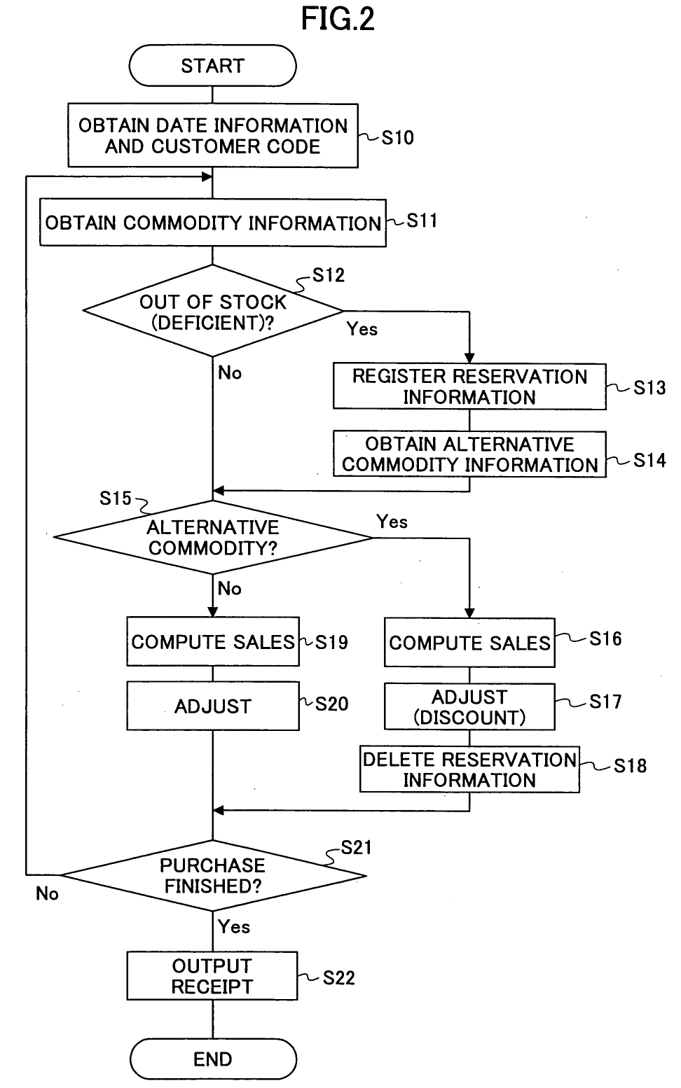

FIG. 2 is a flowchart for explaining the sales supporting method according to an embodiment of the present invention. The flowchart of FIG. 2 shows a sales support procedure in a case of a first time purchase. In this procedure, when a commodity desired by a customer is out of stock, a procedure is executed where the customer either indicates the desire to purchase the deficient commodity or the willingness to settle for an alternative commodity to the POS terminal 30. In Step S10, date information and the customer code (through the read-out control part 32) are obtained from the POS terminal 30. In Step S11, commodity information is obtained through the read-out control part 32. In Step S12, it is determined whether the desired commodity is in stock by referring to the deficient commodity information stored in the deficient commodity information DB in the store computer 20. When it is determined that the desired commodity is out of stock (YES in Step S12), the POS terminal 30 transmits reservation information to the store computer 20 for being registered in the reservation information DB 26 (Step S13). Next, in Step S14, alternative commodity information stored in the alternative commodity information DB 27 is obtained for use in Step S15.

Meanwhile, in Step S15, when the commodity desired by a customer is in stock (NO in Step S12), it is determined whether the purchased commodity is an alternative commodity based on the alternative commodity information. When the purchased commodity is an alternative commodity (YES in Step S15), the sales computation part 35 performs sales computation of the purchased commodity (Step S16). Next, in Step S17, the adjustment part 36 performs an adjustment (discounting) for the purchased alternative commodity. In Step S18, a request to delete reservation information of the commodity corresponding to the discounted alternative commodity is transmitted from the POS terminal 30 to the store computer 20 for deleting the reservation information from the reservation information DB 26.

Meanwhile, when the purchased commodity is not an alternative commodity (NO in Step S15), the sales computation part 35 performs sales computation of the purchased commodity (Step S19). Next, in Step S20, the adjustment part 36 performs an adjustment for the purchased commodity. In Step S21, it is determined whether purchasing of commodities is finished. When the purchasing of commodities is finished (YES in Step S21), the receipt output part 31 outputs a receipt indicative of the sales computation and adjustment results (Step S22).

Accordingly, with the procedure shown in FIG. 2, it is possible to store customer information indicating a desire to purchase a deficient commodity, and also it is possible to discount a commodity being alternatively purchased for a deficient commodity.

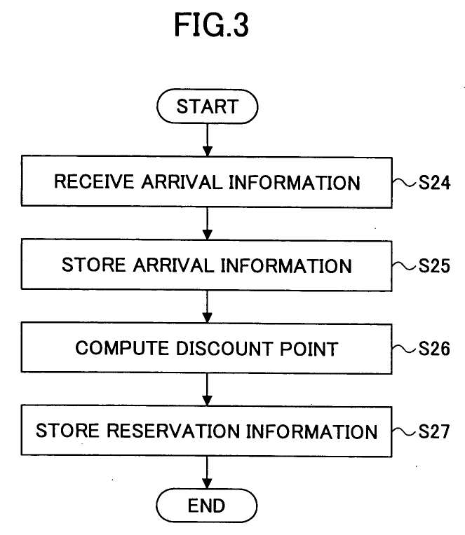

FIG. 3 is a flowchart for explaining the sales supporting method according to an embodiment of the present invention. The flowchart of FIG. 3 shows a sales support procedure in a case of a later (next) time purchase. In Step S24, the store computer 20 receives commodity arrival information (e.g. arrival date, commodity amount) from the commodity management part 61 of the manufacturer terminal 60. In Step S25, the commodity arrival information is stored in the commodity arrival information DB 29. In Step S26, the point computation part 22 computes discount points based on the arrival date in the commodity arrival information. In Step 27, the discount points computed in Step 26 are stored in the reservation information DB 26.

For example, with reference to FIG. 5, in a case where a customer (customer code “001”) reserves a commodity (commodity code “4910”) having a discount rate of 1 point (%) added each day until the day the commodity arrives, the point computation part 22 computes the total discount points by multiplying 1 discount point per day with respect to the number of days between the reservation date “Jan. 25, 2002” and the arrival date “Feb. 4, 2002”. Accordingly, a total discount of 10 points is obtained and stored. In a case where another customer (customer code “023”) reserves another commodity (commodity code “4930”) having a discount rate of 2 points (%), the point computation part 22, in a case where the commodity has not arrived, computes the total discount points by multiplying 2 discount points per day with respect to the number of days between the reservation date “Jan. 25, 2002” and the expected arrival date “Feb. 11, 2002”. Accordingly, a total discount points of 34 points is obtained and stored.

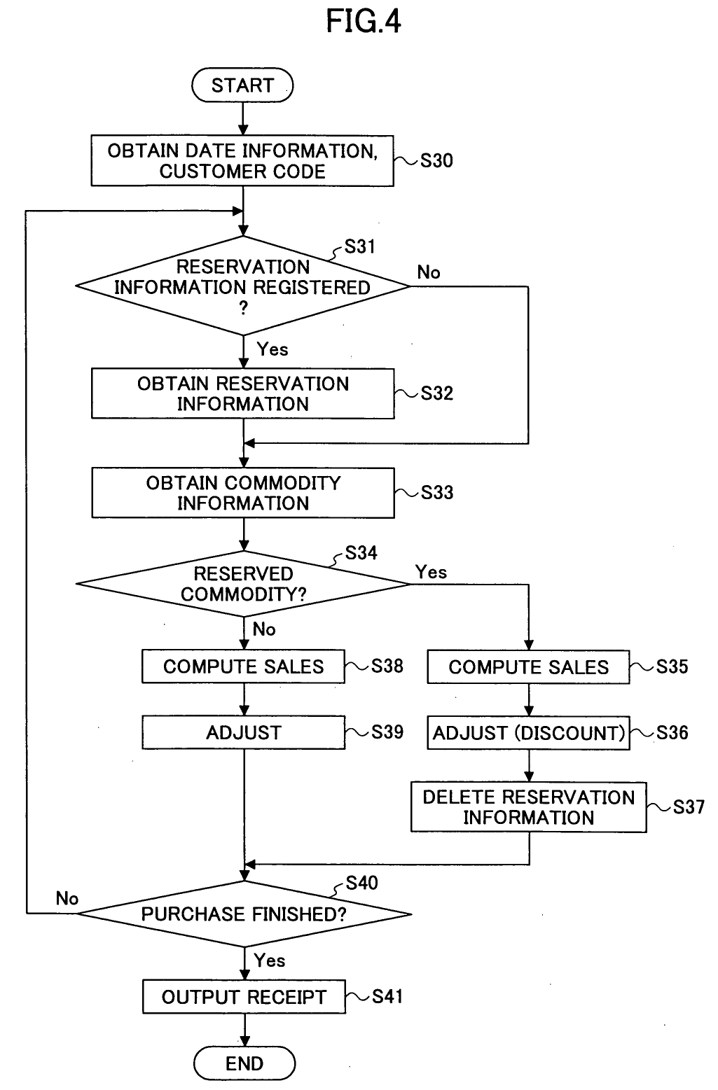

FIG. 4 is another flowchart for explaining the sales supporting method according to an embodiment of the present invention. The flowchart of FIG. 4 shows another sales support procedure in a case of a latter (next) time purchase. In Step S30, date information and the customer code (through the read-out control part 32) are obtained from the POS terminal 30. In Step S31, it is determined whether reservation information corresponding to the obtained customer information is registered in the reservation information DB 26 of the store computer 20. When it is determined that the reservation information is registered (YES in Step S31), the corresponding reservation information is obtained from the reservation information DB 26 of the store computer 20 (Step 32).

Next, in Step S33, commodity information is obtained by the read-out control part 32. In Step S34, it is determined whether the commodity for purchase is a reserved commodity based on the obtained reservation information. When it is determined that the commodity for purchase is a reserved commodity (YES in Step S34), the sales computation part 35 performs sales computation of the commodity for purchase (Step S35). Next, in Step S36, the adjustment part 36 performs an adjustment (discounting) for the reserved commodity.

For example, in a case where a customer (customer code “102”), on the date of “Jan. 25 2002”, purchases canned beer C (reservation commodity code “4920”) registered in the reservation information DB 26 on “Jan. 25, 2002”, the discount points is 14% (14 points). Accordingly, the adjustment part 36 discounts 14% from the net price of canned beer C. In Step S37, a request for deleting the reservation information corresponding to the discounted commodity is transmitted from the POS terminal 30 to the store computer 20 for deleting the reservation information from the reservation information DB 26.

When it is determined that the commodity for purchase is not a reserved commodity (NO in Step S34), the sales computation part 35 performs sales computation of the commodity for purchase (Step S38). Next, in Step S39, the adjustment part 36 performs adjustment of the commodity for purchase. In Step S40, it is determined whether the purchasing of commodities is finished. When the purchasing of commodities is finished (YES in Step S40), the receipt output part 31 outputs a receipt indicative of sales computation and adjustment results (Step S41).

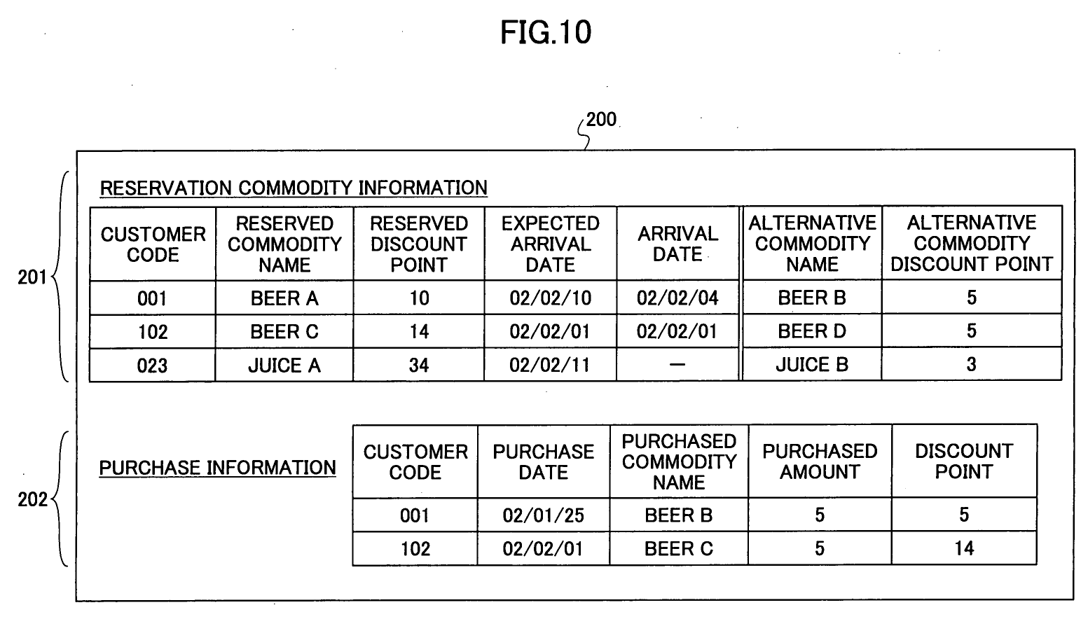

FIG. 10 is a schematic diagram showing an example of a display for explaining the sales supporting method according to an embodiment of the present invention. FIG. 10 shows a display 200 which is displayed by the store computer 20. The display 200 includes a display part 201 for displaying reservation commodity information and a display part 202 for displaying purchase information. The display part 201 displays, for example, data obtained from the reservation information DB 26 and the alternative commodity information DB 27, such as customer codes of the customers reserving the commodities, names of reserved commodities, reservation discount points, expected arrival dates, arrival dates, names of alternative commodities, and alternative commodity discount points. More specifically, for example, according to the first row of the display part 201, the customer code is “001”, the name of the reserved commodity is “canned beer A”, the reservation discount points is “10 points”, the expected arrival date is “Feb. 10, 2002”, the arrival date is “Feb. 4, 2002”, the name of the alternative commodity is “canned beer B”, and the alternative commodity points is “5 points”. The display part 202 displays, for example, customer codes purchasing the commodities, purchase dates, names of purchased commodities, purchased amount, and discount points. More specifically, for example, according to the first row in the display part 202, the customer code is “001”, the purchase date is “Jan. 25, 2002”, the name of the purchased commodity is “canned beer B”, the purchased amount is “5”, and the discount points is “5 points”.

Therefore, by referring to the display 200 including the display parts 201 and 202, it can be conceived, for example, that the customer (customer code “001”) purchased canned beer B on the date of Jan. 25, 2002” as an alternative to reserved canned beer A and received an alternative commodity discount of 5%. In another example, it can be conceived that the customer (customer code “102”) purchased reserved canned beer C on the date of “Feb. 1, 2002” and received a reservation discount of 14%.

FIG. 11A shows an example of a receipt output during the first time of the sales supporting procedure according to an embodiment of the present invention (See FIG. 2). FIG. 11B shows an example of a receipt output during the later time of the sales supporting procedure according to an embodiment of the present invention. The receipt 40 of FIG. 11A includes, for example, a title part 310, a customer code part 311, and commodity information parts 312 and 313. More specifically, the title part 310 includes, for example, the name of the shop “OIMACHI LIQUOR SHOP”, and the purchase date “Jan. 25, 2002”, and the customer code parts 311 includes, for example, the customer code “001”. Further, the commodity information part 312 includes, for example, the commodity code “4814”, the commodity name “JUICE D”, the unit price “@150”, the purchased amount “3”, and the total cost “450 yen”. Further, the commodity information part 313 includes, for example, the commodity code “4911”, the commodity name “CANNED BEER B”, the unit price “@210”, the purchased amount “5”, the total cost “1050 yen”, the alternative commodity discount points “5 (P)”, and the amount of the alternative commodity discount “−52 (yen)”. Here, the receipt 40 indicates that an alternative commodity discount has been applied for purchasing “canned beer B” (as an alternative for canned beer A).

The receipt 41 of FIG. 11B includes, for example, a title part 315, a customer code part 316, and commodity information parts 317 and 318. More specifically, the title part 315 includes, for example, the name of the shop “OIMACHI LIQUOR SHOP”, and the purchase date “Feb. 1, 2002”, and the customer code parts 316 includes, for example, the customer code “102”. Further, the commodity information part 317 includes, for example, the commodity code “4634”, the commodity name “SNACK A”, the unit price “@130”, the purchased amount “2”, and the total cost “260 yen”. Further, the commodity information part 318 includes, for example, the commodity code “4920”, the commodity name “CANNED BEER C”, the unit price “@210”, the purchased amount “5”, the total cost “1050 yen”, the reservation discount points “14 (P)”, and the amount of the reservation discount “−147 (yen)”. Here, the receipt 41 indicates that a reservation discount has been applied for purchasing “canned beer C” (which was out of stock the previous time).

Accordingly, in a case where a desired commodity is out of stock during the first transaction (first time purchase) of the customer, reservation information of the desired commodity may be stored, and a reservation discount can be applied based on the reservation information during the next transaction (later (next) time purchase) of the customer. Further, in a case where a desired commodity is out of stock, an alternative commodity discount can be applied to an alternatively purchased commodity based on stored discount points. Hence, sales profits of the store as well as customer satisfaction can be increased.

In addition, when a reserved commodity arrives, the point computation part 22 can compute the discount points based on the number of days between the reservation date and the arrival date, and can apply the discount with the fixed discount points based on the arrival date stored in the reservation information DB 26.

Further, by outputting the receipts 40, 41 showing the discount results, the customer and operator of the POS terminal 30 can confirm, for example, the price of the discounted commodity or the discounted value. Further, the reservation commodity information and purchase information can be displayed on the display 200 of the store computer 20.

Alternatively, in the sales supporting method (procedure) according to an embodiment of the present invention, the reservation commodity information and the purchase information displayed on the display 200 of the store computer 20 may also be displayed on the POS terminal 30.

Further, as an alternative to storing the arrival date of the commodity in the reservation information DB 26, the deficient commodity information DB 28, and the commodity arrival information DB 29, the date of informing the customer of the arrival may be stored, thereby allowing the point computation part 22 to compute the discount points based on the date of informing the customer of the arrival.

Further, the present invention is not limited to these embodiments, but various variations and modifications may be made without departing from the scope of the present invention.

The present application is based on PCT Application No. 02/03116 filed on Mar. 28, 2002, with the Japanese Patent Office, the entire contents of which are hereby incorporated by reference.

What is claimed is:

1. A method for supporting sales of a commodity to a customer, the method comprising the steps of:
a) computing a first discount value for a deficient commodity desired by the customer, by referring to arrival information of the deficient commodity;
b) storing desired commodity information that is stored in correspondence with the obtained first discount value, the commodity information including details of the deficient commodity, and customer identification information including identification information of the customer; and
c) discounting the price of the desired deficient commodity in accordance with the obtained first discount value, in a case where the customer purchases the desired deficient commodity.

2. The sales supporting method as claimed in claim 1, further comprising a step of:
d) storing alternative information including information of an alternative commodity that is alternatively purchasable for the desired deficient commodity, and a second discount value corresponding to the alternative commodity.

3. The sales supporting method as claimed in claim 2, further comprising a step of:
e) discounting the price of the alternative commodity in accordance with the second discount value, in a case where the customer purchases the alternative commodity.

4. The sales supporting method as claimed in claim 3, further comprising a step of:
f) outputting a receipt indicative of discount results for at least one of the discounted price according to the first discount value and the discounted price according to the second discount value.

5. The sales supporting method as claimed in claim 4, further comprising a step of:
g) storing purchase information including at least one of the discounted price according to the first discount value and the discounted price according to the second discount value.

6. The sales supporting method as claimed in claim 5, further comprising a step of:
h) deleting the desired deficient commodity information and the alternative commodity information corresponding to the discounted desired commodity.

7. The sales supporting method as claimed in claim 6, further comprising a step of:
i) displaying the desired commodity information and the purchase information.

8. A program for enabling a computer to execute a sales supporting method, the program comprising the functions of:
a) computing a first discount value for a deficient commodity desired by the customer, by referring to arrival information of the deficient commodity;
b) storing desired commodity information that is stored in correspondence with the obtained first discount value, the commodity information including details of the deficient commodity, and customer identification information including identification information of the customer; and
c) discounting the price of the desired deficient commodity in accordance with the obtained first discount value, in a case where the customer purchases the desired deficient commodity.

9. A recording medium stored with a program for enabling the computer to execute the sales supporting method, the recording medium comprising:
the program as claimed in claim 8.
